(19) United States
(12) Patent Application Publication
(10) Pub. No.: US 2026/0103090 A1
(43) Pub. Date: Apr. 16, 2026

(54) LONG-LASTING HIGH-POWER BATTERY PROTECTION SYSTEM WITH INTELLIGENT MANAGEMENT

(71) Applicants: KUO-HSIN SU, NEW TAIPEI CITY (TW); TA-YU SU, NEW TAIPEI CITY (TW); HSUN-I LEE, NEW TAIPEI CITY (TW)

(72) Inventors: KUO-HSIN SU, NEW TAIPEI CITY (TW); TA-YU SU, NEW TAIPEI CITY (TW); HSUN-I LEE, NEW TAIPEI CITY (TW)

(21) Appl. No.: 18/915,682

(22) Filed: Oct. 15, 2024

(51) Int. Cl. B60L 50/60; B60L 58/15; H02J 7/00

(52) U.S. Cl. CPC B60L 50/60; B60L 58/15; H02J 7/52

(57) ABSTRACT

A long-lasting high-power battery protection system with intelligent management includes a battery cell, and a battery management system including a secondary control system, a low-power switching element, a high-capacity relay, a battery cell voltage balancing system and a surge absorption cell connected in parallel to the battery. Through the battery cell voltage balancing system, the voltage difference between each battery cell is effectively controlled. At the same time, by connecting the surge absorption cell in parallel to the battery, the instantaneous voltage surge on the power rail can be effectively eliminated without causing damage to the expensive vehicle electronic control units (ECUs), thereby achieving the purpose of protecting vehicle components.

### BACKGROUND OF THE INVENTION

### 1. Field of the Invention

The present invention relates to battery protection system technology and more particularly, to a long-lasting high-power battery protection system with intelligent management that effectively controls the path of a large current generated instantaneously when the vehicle is started, so as to protect battery cells and other circuits in the battery management system (BMS), and provide the long-lasting high-power battery protection system for vehicle electronic control units (ECUs) load equipment protection.

### 2. Description of the Related Art

This invention is an improvement on the invention patent Ser. No. 18/365,324 “Long-term high-power battery system with intelligent management” previously applied by the inventor of this case. In addition to the auxiliary control system, low-power switch components, high-capacity relays and battery cell voltage balancing system provided in the battery management system (BMS) of the previous invention, the purpose of protecting the battery cells and other circuits in the battery management system (BMS) and greatly increasing the battery life is achieved. At the same time, by connecting a surge absorber cell in parallel to the outside of the battery, the instantaneous voltage surge on the power supply track can effectively eliminate the damage to the expensive vehicle electronic control units (ECUs) and simultaneously achieve the purpose of protecting vehicle components.

The inventor of this case has mentioned in the patent application Ser. No. 18/365,324 entitled “Long-term high-power battery system with intelligent management” that the design of the conventional vehicle battery, as shown in FIG. 5, is provided in the battery management system (BMS) 5 with a charging and discharging transistor switch unit 52 for the passing of charging discharging high power current 42 to charge the battery cells 41 of the battery 4 or supply the starting motor current when starting the engine. The charging and discharging transistor switch unit 52 is composed of a plurality of charging and discharging transistor switches 521 connected in parallel. Because the vehicle will generate a very large current when the engine is started, but the current load of the charging and discharging transistor switches 521 used in the design of the conventional battery management system 5 of the battery 4 is quite small and the charging and discharging transistor switch unit 52 of the conventional battery management system (BMS) 5 of the battery 4 is set on the circuit of the high power current 42, the conventional battery 4 is designed in the battery management system (BMS) 5 to be able to carry the large current generated instantaneously when the vehicle is started. Therefore, it is necessary to use a large number of charging and discharging transistor switches 521. However, due to the high price of the charging and discharging transistor switches 521, the design of the conventional battery 4 using a large number of charging and discharging transistor switches 521 has greatly increased the cost and selling price.

Moreover, a large number of charging and discharging transistor switches 521 are used in the conventional battery 4. Because the battery 4 is installed in the high-temperature engine room, in addition to the poor heat dissipation function of the charging and discharging transistor switches 521, the temperature will also be generated when it is working, plus the high temperature in the engine room, the charging and discharging transistor switches 521 are easily damaged, and the replacement of the battery 4 will be needed. Although there is an overload, overcharge, overdischarge and overtemperature control circuit 51 and battery cell voltage balancing system 53 in the conventional battery management system (BMS) 5, it is arranged on the charging and discharging circuit of high power current 42, so the effect is limited. Moreover, when the vehicle is started, the large current generated by the generator 56 will instantly pass through each charge-discharge transistor switch 521 of the charge-discharge transistor switch unit 52, and because the charging and discharging transistor switches 521 cannot carry the instantaneously large current, each charging and discharging transistor switch 521 will generate high temperature. The high temperature generated in this situation will cause the charging and discharging transistor switches 521 to fail and be damaged in the state of accumulating the instantaneous large current during multiple startups to generate high temperature. And this high temperature will also cause the circuit and contact solder of each charging and discharging transistor switch 521 to separate due to high temperature melting, or cause poor contact, which will cause the battery 4 to be unusable and shorten the life of the battery 4. There are companies install a cooling system 54 on the charging and discharging transistor switch unit 52. As shown in FIG. 6, although this method can reduce the temperature slightly, the effect is limited, and in addition to increasing the cost, it also increases the volume of the product.

Furthermore, modern cars use increasingly advanced electronic technology and more complex components. Modern cars generally use a main battery with a battery management system (BMS), a generator, and a variety of expensive vehicle loads 55 vehicle electronic control units (ECUs), all connected in parallel on a DC power supply track and implemented in different wiring methods. In order to prevent overcharge and overvoltage of the battery, the battery management system (BMS) stops charging the battery, which is a necessary protection action for all battery management systems (BMS) to avoid all possible dangers caused by overcharge and overvoltage of the battery. This action is equivalent to instantly disconnecting the charging equipment and the battery cells on the system power supply track. If a decoupling method suitable for the system power is not selected, it may cause damage to the vehicle electronic control units (ECUs) of the vehicle load 55 (as shown in FIG. 7).

When the car power supply track is used to start the motor, the power delivered is quite high. In addition, due to modern environmental protection requirements, more and more vehicles are equipped with a start-stop system (the engine automatically shuts down when the vehicle stops and automatically starts when the vehicle starts). However, the start-stop system will increase the number of starts and stops when the road conditions are crowded. In addition to causing the charging and discharging transistor switch 521 (as shown in FIG. 5) to be forced to enter the temperature protection of the transistor switch 521 due to the accumulated heat of multiple starts and stops, it also increases the chance of transient surges. The reason is that the starting motor is an inductive load. After the starting motor is started, the rotor part begins to rotate and cuts the magnetic field to generate a counter electromotive force, which in turn generates a surge that interferes with the power supply track. The greater the power of the starting motor, the stronger the surge energy.

When the battery is over-voltaged due to the above conditions, the battery management system (BMS) in the battery will proactively disconnect the battery from the charging equipment of the generator on the system power supply track. However, this action will generate a momentary voltage surge (as shown in FIG. 8), which can easily damage any load on the power supply track, such as expensive vehicle electronic control units (ECUs) such as power steering control module, engine ignition control module, gear shift control module, power window control module, etc.

In the current market, in addition to the fact that the battery management system (BMS) design of the battery is generally insufficient in terms of carrying power, the different starting and stopping powers required by various vehicles pose a great challenge to the battery management system (BMS)'s ability to stabilize the rail voltage. Furthermore, it is uneconomical, bulky, and prone to failure for vehicle designers to use a precision, low-power decoupling network at the power input of each vehicle electronic control unit (ECUs). It is also highly recommended not to use an inductor current suppressor because the inductor is prone to electromagnetic interference, and the commonly used transient voltage suppression diode (TVS), varistor (MOV) or charge-discharge transistor switch 521 slow start or slow stop technology also has different starting or power generation requirements for different vehicles. The battery management system (BMS) of the battery is difficult to match accurately, and failure is inevitable.

Electrically, this type of power surge absorption circuit is called a de-coupling network. It is often used on the power input side of each load to remove input power noise and stabilize power supply to avoid unnecessary damage to the precision core control or calculation circuit at the back end of the input side. However, it is difficult to choose the most appropriate decoupling method for systems with different power transmission.

Currently, some vehicle design manufacturers use a precision low-power decoupling network for the power input of each vehicle electronic control unit (ECU). This is not only uneconomical, but also increases the size and is prone to failure. It is also highly recommended not to use inductive overflow, because the inductor will generate a lot of electromagnetic interference, and the commonly used transient voltage suppression diode (TVS), varistor (MOV) or charge-discharge transistor switch 521 slow start or slow stop technology also has different starting or power generation requirements for different vehicles. The battery management system (BMS) of the battery is difficult to match accurately, and failure is inevitable.

Some companies also use a powerful capacitive voltage regulator on the power supply track as the most effective way. However, the capacitance required for capacitive filtering in this application is quite high. Tests have shown that capacitors that do not reach the supercapacitor level cannot effectively absorb this surge. However, the cost of using supercapacitors is high, and because a single supercapacitor has a very low withstand voltage, an external voltage balancing circuit and a protection circuit are still required. This also means that the supercapacitor module, which was originally designed to absorb surges and provide stable power, still has a certain probability of being disconnected from the power supply track and failing to perform the surge absorption function.

In summary of the above considerations, as shown in FIG. 5, the charge and discharge transistor switch 521 of the known battery management system (BMS) 5 often fails and melts due to high temperature. The design of the known vehicle battery also cannot effectively solve the problem of instantaneous voltage surges (as shown in FIG. 8) causing damage to any load on the power supply track, such as expensive vehicle electronic control units (ECUs).

The prior application Ser. No. 18/365,324 of the present invention, “Long-term high-power battery system with intelligent management”, has solved the known temperature problem of the charge and discharge transistor switch 521 as shown in FIG. 5. Therefore, the present invention is to solve the problem that the instantaneous voltage surge (as shown in FIG. 8) frequently generated by the vehicle start-stop system causes damage to any load on the power supply track, such as expensive vehicle electronic control units (ECUs).

### SUMMARY OF THE INVENTION

The present invention provides a long-lasting high-power battery protection system with intelligent management, which comprises a battery with at least one battery cell installed therein, and a battery management system (BMS). The battery management system (BMS) comprises a secondary control system, a low-power switching element, a high-capacity relay, and a battery cell voltage balancing system. The long-lasting high-power battery protection system of the present invention is equipped with a high-power current circuit for charging and discharging, and a circuit of low-power load current. The battery management system, the secondary control system, the low-power switching element and the battery cell voltage balancing system are all connected to the circuit of low-power load current, and the high-capacity relay that can carry a large current is set on the circuit of high-power current of charging and discharging, so as to divide the high-current and low-current circuits. The secondary control system comprises an overload, overcharge, overdischarge and overtemperature control circuit, a load detection and pre-charge control circuit, and an emergency start control circuit. If any battery cell of the battery is overloaded, overcharged, overdischarged or overheated, the high-capacity relay will be closed by the overload, overcharge, overdischarge and overtemperature control circuit to interrupt all current and the circuit of low-power load current to protect the battery cells of the battery. When the load detection and pre-charge control circuit in the secondary control system detects a high current load generated by the vehicle startup through the low-power switching element, the low-power switching element cuts off the high load connected to the battery management system (BMS) first, and immediately activates the high-capacity relay set on the circuit of high-power current for charging and discharging through the load detection and pre-charge control circuit, so that large current can pass through the high-capacity relay to provide vehicle load such as engine starter motor with high current required when starting the engine, so as to protect low-power switching element, reduce volume, reduce failure probability and cost.

Preferably, the battery cell voltage balancing system comprises a voltage balancing control circuit and a high-efficiency charging and discharging micro-battery. The high-efficiency charging and discharging micro-battery is arranged in parallel with a plurality of transistor switches corresponding to each battery cell of the battery. When the generator of the vehicle charges the battery and the voltage difference between each battery cell of the battery is too high, the voltage balancing control circuit will instantly turn on the transistor switch connected to the high voltage battery cell, so as to immediately transfer the overcharge energy of the battery cell to the high-efficiency charging and discharging micro-battery, then the voltage balancing control circuit turns on the transistor switch connected to the lower voltage battery cell, so as to instantly transfer the electric energy transferred to the high-efficiency charging and discharging micro-battery to the low voltage battery cell, so as to achieve the voltage balance of each battery cell, and then protect the battery cells of the battery and greatly increase the life of the battery.

Preferably, the load detection and pre-charge control circuit can perform bidirectional pre-charging and recharging control on vehicle loads such as engine starter motor capacitors or generator. At the same time, the load detection and pre-charge control circuit not only detects the load of the battery cells of the battery, but also has a low-power load current circuit connected to the low-power switching element. When the vehicle is started, a large current load will be generated instantaneously. At this time, the load detection and pre-charge control circuit will detect the instantaneously generated high current load through the low-power switching element when the vehicle is started. The low-power switching element first interrupts the high load connected to the battery management system (BMS), and immediately starts the high-capacity relay through the load detection and pre-charge control circuit, so that all the high current generated at the moment of starting the vehicle passes through the high-capacity relay installed on the high-power current circuit of charging and discharging, providing the large current required by the vehicle load such as the engine starter motor at the moment of starting the engine and protecting the battery cells of the battery and the electronic parts in the battery management system (BMS) from being damaged by instantaneous high current.

Preferably, the emergency start control circuit has the function of detecting the power of the battery cells of the battery. When the vehicle is parked for too long and the power of the battery cells of the battery is reduced at least enough to start the engine, the emergency start control circuit will interrupt the output of the battery to preserve the remaining power of the battery cells of the battery. When the vehicle is to be restarted, it is only necessary to turn on the forced switch located on the emergency start control circuit to forcibly turn on the power of the battery, so as to achieve the purpose of starting the engine and preventing the battery cells of the battery from being permanently damaged due to exhaustion of power.

In addition, the present invention is to solve the problem that when the vehicle power supply track is used to start the motor, the high power is generated, that is, when the vehicle with a start-stop system is in crowded road conditions, the number of starts and stops will increase, thereby increasing the chance of transient surges. When the battery over-voltage occurs in the internal cells due to the above conditions, the battery management system (BMS) of the battery will proactively disconnect the cells in the battery from the charging equipment of the generator on the system power supply track, resulting in an instantaneous voltage surge, which can easily damage the multiple expensive vehicle electronic control units (ECUs) on the power supply track, such as the power steering control module, engine ignition control module, gear shift control module, power window control module, etc. A surge absorber is connected in parallel to the battery of the battery management system (BMS) of the battery. The surge absorber effectively and quickly absorbs the instantaneous voltage surge generated by the instantaneous disconnection of the charging equipment of the generator, so that no instantaneous voltage surge is generated on the power supply track, thereby preventing damage to all vehicle loads on the power supply track, such as expensive vehicle electronic control units (ECUs). Moreover, even after the life cycle (Cycles) of this surge absorption battery, it still has the ability to absorb surges without affecting normal functions.

After passing through the surge absorption battery, the surge absorption battery will never be disconnected from the power supply track. Because the capacity of the surge absorption battery is much higher than that of ordinary capacitors, the surge energy that can be loaded is also relatively high, and there will be no different starting or power generation power required by different vehicles.

The advantages of the present invention are as follows:
1. The present invention is mainly to connect a surge absorber cell in parallel to the battery of a battery management system (BMS) with a battery, and to effectively and quickly absorb instantaneous voltage surges through the surge absorber cell to prevent damage to any load on the power supply track, such as expensive vehicle electronic control units (ECUs).
2. The design of the present invention uses a surge absorber cell to effectively eliminate the above-mentioned problems. Moreover, the surge absorption battery still has the ability to absorb surges after the life cycle (cycles) is used up. It has the advantages of easy maintenance, low cost and simple design.
3. The design of the present invention uses a surge absorber cell to effectively eliminate the aforementioned problems. When a transient voltage surge occurs, the surge absorber cell will never be disconnected from the power supply track. Moreover, because its capacitance is much higher than that of ordinary capacitors, the surge energy it can bear is also relatively high, and there will be no different starting or power generation powers required for different vehicles. Unlike the transient voltage suppression diode (TVS), varistor (MOV) or charge and discharge transistor switch slow start or slow stop matching power errors commonly seen in battery management systems (BMS), the power supply track voltage regulation failure problem will not occur.
4. The present invention is to use the secondary control system of the battery management system (BMS) to detect the instantaneously generated high current load when the vehicle is started, then the low-power switching element\ first interrupts the high load connected to the battery management system (BMS), and immediately starts the high-capacity relay on the charging and discharging high-power current circuit, so that the high-capacity relay can pass through the high-capacity relay, so that all the high current generated at the moment of starting the vehicle passes through the high-capacity relay, providing the large current required by the vehicle load such as the engine starter motor at the moment of starting the engine, effectively controlling the path that generates a large current when the vehicle is started, and effectively remove many common design flaws in the previous technology charging and discharging transistor switch: insufficient current load, excessive use, excessive volume, high cost, additional cooling system required, difficult to dissipate heat in a difficult environment, easy to fail, easy to melt solder joints and shorten the circuit life.
5. The present invention is mainly to reduce the usage of a large amount of capacitors while avoiding the use of resistors to waste a large amount of precious electric energy. Through the battery cell voltage balancing system, the voltage difference between each battery cell is effectively controlled, and the electric energy of the battery cell is transferred to the high-efficiency charging and discharging micro-battery in real time. At the same time, the voltage balancing control circuit turns on the transistor switch connected to the low voltage battery cell, so as to instantly transfer the electric energy transferred to the high-efficiency charging and discharging micro-battery to the low voltage battery cell, so as to achieve the voltage balance of each battery cell, effectively transfer the overcharge energy without wasting it, have the effect of small size and low cost, protect the battery cell and greatly increase the battery life.

### BRIEF DESCRIPTION OF THE DRAWINGS

FIG. 1 is a system block diagram of one preferred embodiment of the present invention.

FIG. 2 is the battery cell voltage balancing system diagram of the present invention.

FIG. 3 is another block diagram of the power supply track of the system of the present invention.

FIG. 4 shows that after the present invention adds a surge absorbing cell, there is no instantaneous voltage surge on the power supply rail when the generator and the cell in the battery are instantly disconnected.

FIG. 5 is a block diagram of a conventional battery management system (BMS).

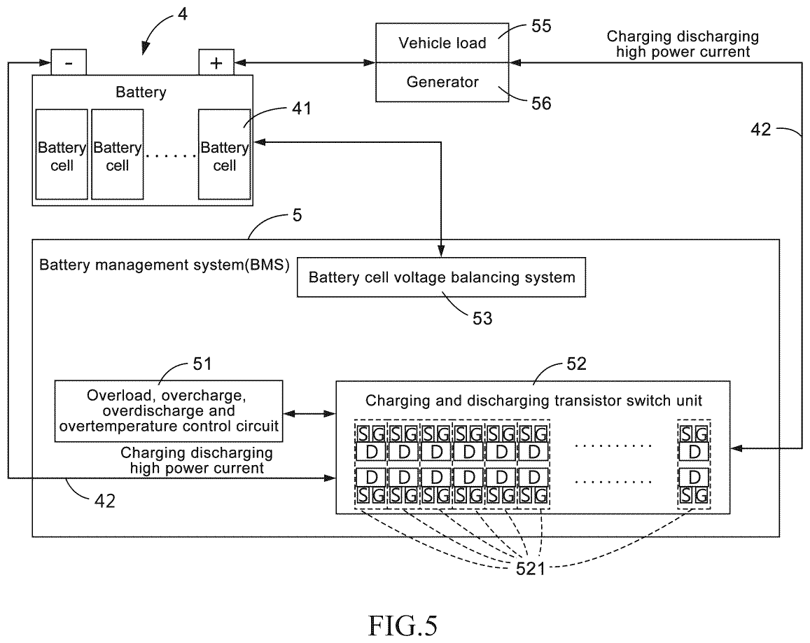

FIG. 6 is a block diagram of the known battery management system (BMS) shown in FIG. 5 having a heat dissipation system.

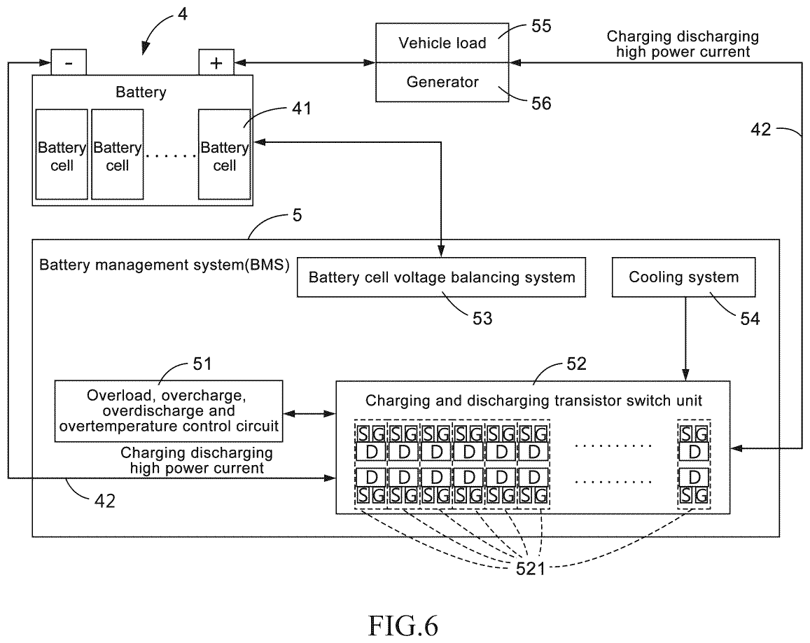

FIG. 7 is another block diagram of the known battery management system (BMS) power supply track.

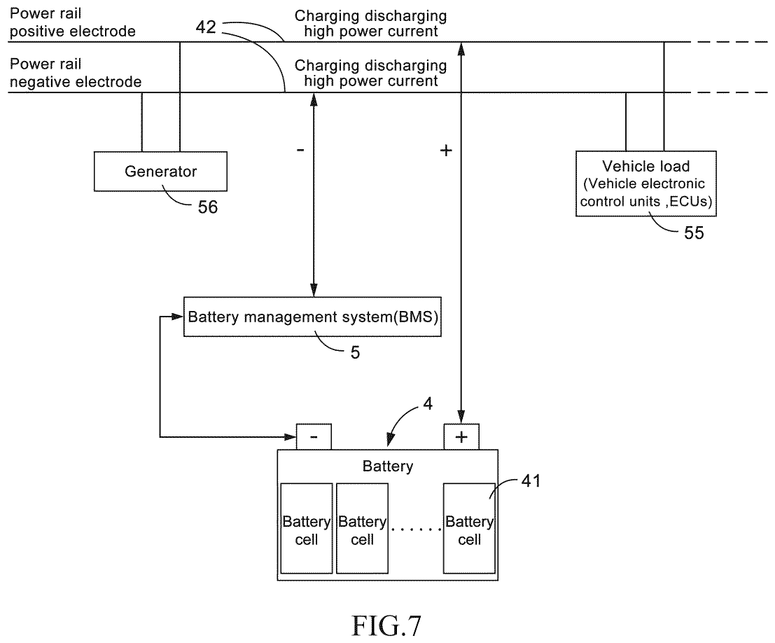

FIG. 8 shows the instantaneous voltage surge generated on the power rail when the generator and the battery cells are momentarily disconnected.

### DETAILED DESCRIPTION OF THE PREFERRED EMBODIMENT

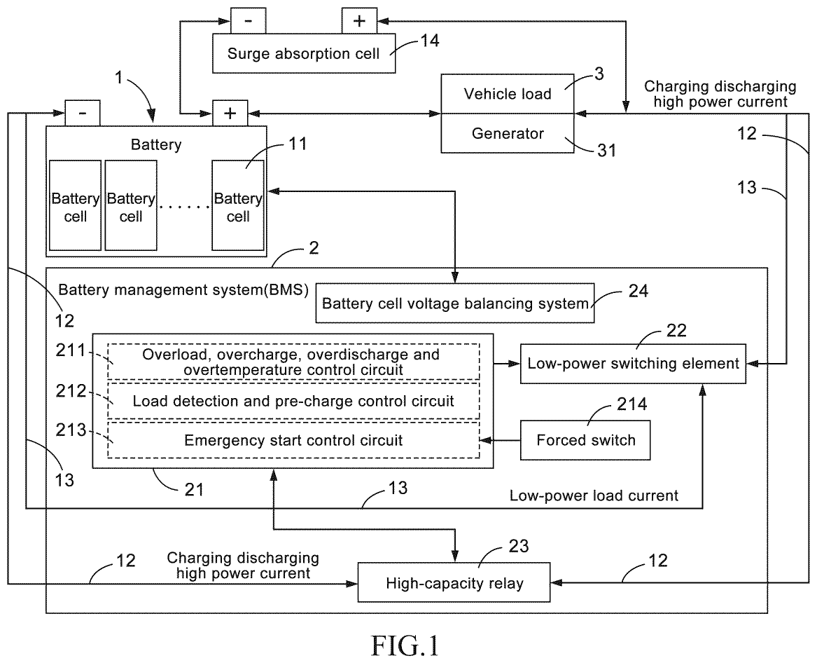

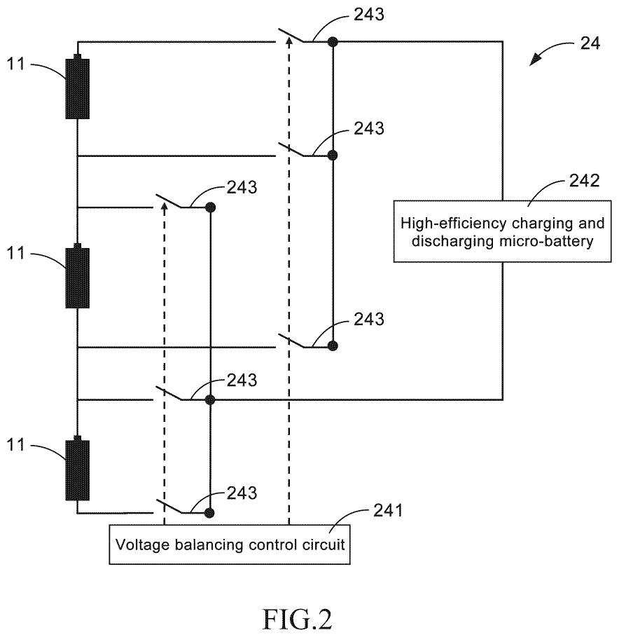

Please refer to FIG. 1, the present invention relates to a long-lasting high-power battery protection system with intelligent management, which comprises a battery 1 with at least one battery cell 11 installed therein, and a battery management system (BMS) 2. The battery management system (BMS) 2 comprises a secondary control system 21, a low-power switching element 22, a high-capacity relay 23, and a battery cell voltage balancing system 24. The long-lasting high-power battery protection system of the present invention is equipped with a circuit of charging discharging high power current 12 for charging and discharging, and a circuit of low-power load current 13. The battery management system (BMS) 2, the secondary control system 21, the low-power switching element 22 and the battery cell voltage balancing system 24 are all connected to the circuit of low-power load current 13, and the high-capacity relay 23 that can carry a large current is set on the circuit of charging discharging high power current 12, so as to divide the high-current and low-current circuits. When the load detection and pre-charge control circuit 212 in the secondary control system 21 detects a high current load generated by the vehicle startup through the low-power switching element 22, the low-power switching element 22 cuts off the high load connected to the battery management system (BMS) 2 first, and immediately activates the high-capacity relay 23 set on the circuit of charging discharging high power current 12 through the load detection and pre-charge control circuit 212, so that large current can pass through the high-capacity relay 23 to provide vehicle load 3 such as engine starter motor with high current required when starting the engine, so as to protect low-power switching element 22, reduce volume, reduce failure probability and cost. The battery cell voltage balancing system 24 comprises a voltage balancing control circuit 241 and a high-efficiency charging and discharging micro-battery 242. The high-efficiency charging and discharging micro-battery 242 is arranged in parallel with a plurality of transistor switches 243 corresponding to each battery cell 11 of the battery 1. When the generator 31 of the vehicle charges the battery 1 and the voltage difference between each battery cell 11 of the battery 1 is too high, the voltage balancing control circuit 241 will instantly turn on the transistor switch 243 connected to the high voltage battery cell 11, so as to immediately transfer the overcharge energy of the battery cell 11 to the high-efficiency charging and discharging micro-battery 242, then the voltage balancing control circuit 241 turns on the transistor switch 243 connected to the lower voltage battery cell 11, so as to instantly transfer the electric energy transferred to the high-efficiency charging and discharging micro-battery 242 to the low voltage battery cell 11, so as to achieve the voltage balance of each battery cell 11 (as shown in FIG. 2), and then protect the battery cells 11 of the battery 1 and greatly increase the life of the battery 1.

The secondary control system 21 comprises an overload, overcharge, overdischarge and overtemperature control circuit 211, a load detection and pre-charge control circuit 212, and an emergency start control circuit 213. If any battery cell 11 of the battery 1 is overloaded, overcharged, overdischarged or overheated, the high-capacity relay 23 will be closed by the overload, overcharge, overdischarge and overtemperature control circuit 211 to interrupt all current and the circuit of low-power load current 13 to protect the battery cells 11 of the battery 1. Normally, the load detection and pre-charge control circuit 212 detects whether the current load needs more power through the low-power switching element 22 to decide whether to start the high-capacity relay 23. The overload, overcharge, overdischarge and overtemperature control circuit 211 will immediately disconnect the low-power switching element 22 and the high-capacity relay 23 during overload, overcharge, overdischarge and overtemperature. The low-power switching element 22 is a bi-directional selectable transistor switch.

The load detection and pre-charge control circuit 212 can perform bidirectional pre-charging and recharging control on vehicle loads 3 such as engine starter motor capacitors or generator 31. At the same time, the load detection and pre-charge control circuit 212 not only detects the load of the battery cells 11 of the battery 1, but also has a low-power load current circuit connected to the low-power switching element 22. When the vehicle is started, a large current load will be generated instantaneously. At this time, the load detection and pre-charge control circuit 212 will detect the instantaneously generated high current load through the low-power switching element 22 when the vehicle is started. The low-power switching element 22 first interrupts the high load connected to the battery management system (BMS) 2, and immediately starts the high-capacity relay 23 through the load detection and pre-charge control circuit 212, so that all the high current generated at the moment of starting the vehicle passes through the high-capacity relay 23 installed on the circuit of charging discharging high power current 12, providing the large current required by the vehicle load 3 such as the engine starter motor at the moment of starting the engine and protecting the battery cells 11 of the battery 1 and the electronic parts in the battery management system (BMS) 2 from being damaged by instantaneous high current.

The emergency start control circuit 213 has the function of detecting the power of the battery cells 11 of the battery 1. When the vehicle is parked for too long and the power of the battery cells 11 of the battery 1 is reduced at least enough to start the engine, the emergency start control circuit 213 will interrupt the output of the battery 1 to preserve the remaining power of the battery cells 11 of the battery 1. When the vehicle is to be restarted, it is only necessary to turn on the forced switch 214 located on the emergency start control circuit 213 to forcibly turn on the power of the battery 1, so as to achieve the purpose of starting the engine and preventing the battery cells 11 of the battery 1 from being permanently damaged due to exhaustion of power.

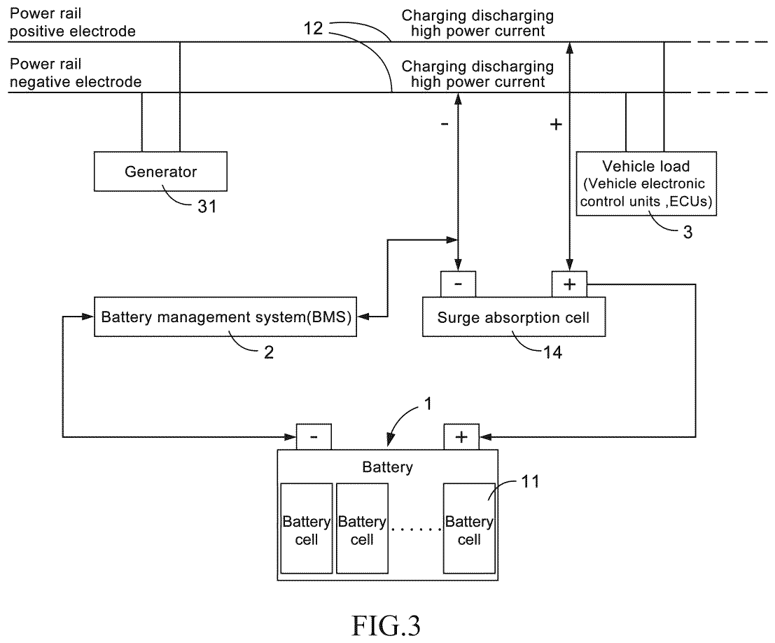

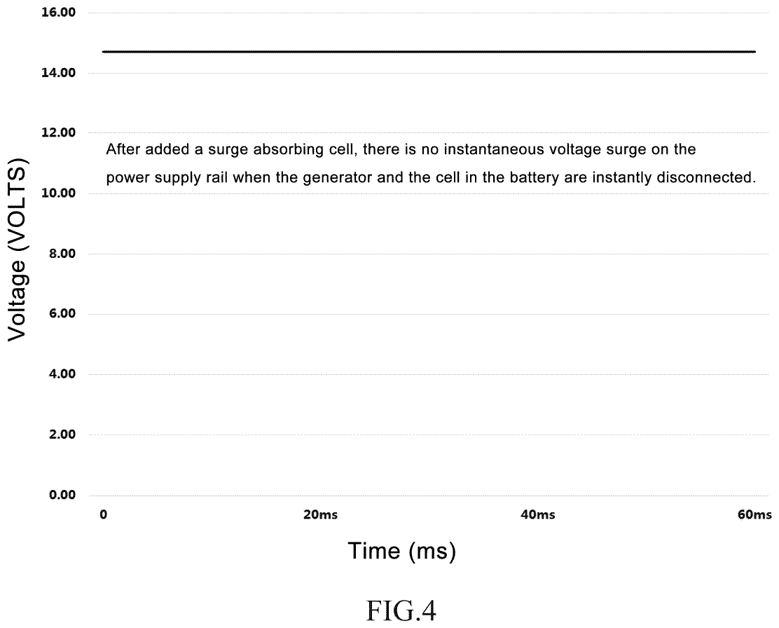

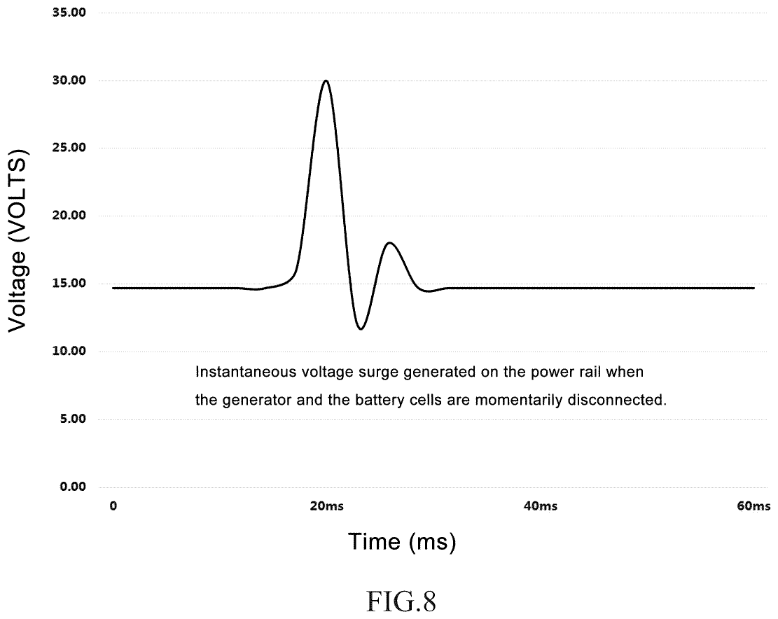

In addition, the present invention is to solve the problem that when the power rail of the car is used to start the motor, the high power is generated. That is, the vehicle has a start-stop system (the engine automatically shuts down when the vehicle stops, and the engine automatically starts when the vehicle starts). When the vehicle is on a crowded road, the number of starts and stops will increase, which increases the chance of transient surges. When the battery 1 is over-voltaged in the battery cells 11 due to the above-mentioned condition, the battery management system (BMS) 2 of the battery 1 will actively disconnect the battery cells 11 in the battery 1 from the charging device of the generator 31 on the system power rail, generating an instantaneous voltage surge, as shown in FIG. 8, which is likely to damage the multiple expensive vehicle electronic control units (ECUs) on the power rail, such as the power steering control module, engine ignition control module, gear shift control module, power window control module, etc. It is to connect a surge absorption cell 14 in parallel to the battery 1. The surge absorption cell 14 effectively and quickly absorbs the instantaneous voltage surge generated by the instantaneous disconnection of the charging device of the generator 31, and no instantaneous voltage surge is generated on the power rail (as shown in FIG. 4), so as to prevent damage to all vehicle loads 3 on the power rail, such as expensive vehicle electronic control units (ECUs). Furthermore, even after the life cycle of the surge absorption cell 14 is over, it still has the ability to absorb surges without affecting the normal function (as shown in FIG. 1 and FIG. 3).

After passing through the surge absorption cell 14, the surge absorption cell 14 will never be disconnected from the power supply rail, and because the capacitance of the surge absorption cell 14 is much higher than that of ordinary capacitors, the surge energy that can be loaded is also relatively high, and there will be no difference in starting or generating power required by various vehicles. The surge absorption cell may be a surge absorption cell of different specifications.

In summary, the present invention provides an effective way to control the large current generated instantly when the vehicle is started, and quickly transfers the overcharged high-voltage battery cells to the low-voltage battery cells to produce a voltage balance for each battery cell, thereby protecting the battery cells, greatly increasing the battery life, and greatly reducing the failure rate and manufacturing cost. The surge absorption cell can effectively and quickly absorb the instantaneous voltage surge caused by the instantaneous disconnection of the charging equipment of the generator to prevent damage to all vehicle loads on the power supply track, such as expensive vehicle electronic control units (ECUs).

What is claimed is:

1. A long-lasting high-power battery protection system with intelligent management used in a vehicle, comprising a battery, a battery management system (BMS), a high-power current circuit for charging and discharging and a low-power load current circuit, said battery comprising a plurality of battery cells therein, said battery having positive and negative electrodes thereof connected to the battery management system (BMS), said battery management system (BMS) comprising a secondary control system, a low-power switching element, a high-capacity relay and a battery cell voltage balancing system, said battery management system and said low-power switching element being connected to said low-power load current circuit, said high-capacity relay being capable of carrying a large current and being set on said high-power current circuit to divide the high-current and low-current circuits, wherein when said secondary control system detects the high current load generated by the vehicle startup, said low-power switching element first interrupts the high load connected to said battery management system (BMS), and immediately activates said high-capacity relay set on said high-power current circuit through said secondary control system, so that the large current is allowed to pass through said high-capacity relay to provide the high current required by the vehicle load equipment such as the engine starter motor when starting the engine, so as to protect said low-power switching element, said battery cell voltage balancing system comprising a voltage balancing control circuit and a high-efficiency charging and discharging micro battery, said high-efficiency charging and discharging micro battery being arranged in parallel with a plurality of transistor switches corresponding to each said battery cell of said battery, so that when the vehicle's generator is charging said battery, if the voltage difference between each said battery cell is too high, said voltage balancing control circuit instantly opens the respective said transistor switch connected to the respective said high-voltage battery cell to immediately transfer the overcharge energy of the said high-voltage battery cell to said high-efficiency charging and discharging micro battery, then said voltage balancing control circuit opens the respective said transistor switch connected to the respective lower voltage battery cell to instantly transfer the energy transferred to said high-efficiency charging and discharging micro battery to the respective said low voltage battery cell to achieve voltage balance in each battery cell, wherein the long-lasting high-power battery protection system with intelligent management further comprises a surge absorption cell connected in parallel to said battery to effectively and quickly absorb the instantaneous voltage surge generated by the instantaneous disconnection of the charging equipment of the generator of the vehicle to prevent generation of instantaneous voltage surge on the power supply rail of the vehicle, thereby preventing damage to all vehicle loads on the power supply rail, such as expensive vehicle electronic control units (ECUs).

2. The long-lasting high-power battery protection system with intelligent management as claimed in claim 1, wherein said surge absorption cell is selected from a group of surge absorption cells of different specifications.

3. The long-lasting high-power battery protection system with intelligent management as claimed in claim 1, wherein said surge absorption cell needs not to be replaced even after the life cycle of said surge absorption cell has ended, and still has the ability to absorb surges with no affectiveness on normal functions.

4. The long-lasting high-power battery protection system with intelligent management as claimed in claim 1, wherein said surge absorption cell effectively and quickly absorbs the instantaneous voltage surge caused by the instantaneous disconnection of the charging equipment of the generator of the vehicle, and said surge absorption cell is disconnectable from the power supply rail of the vehicle, and the capacity of said surge absorption cell is much higher than that of ordinary capacitors, the surge energy that can be loaded is also relatively high, and there is no different starting or power generation powers required by different vehicles.
